(19) United States
(12) Patent Application Publication
(10) Pub. No.: US 2026/0245790 A1
(43) Pub. Date: Aug. 20, 2026

(54) METHOD FOR PACKAGING SHEET METAL PARTS MADE FROM AN ELECTRICAL STEEL STRIP OR SHEET TO FORM A LAMINATED CORE

(71) Applicant: voestalpine Stahl GmbH, Linz (AT)

(72) Inventor: Ronald Fluch, Linz (AT)

(21) Appl. No.: 19/161,374

(22) PCT Filed: Mar. 4, 2024
(86) PCT No.: PCT/EP2024/055595

§ 371 Date: Sep. 2, 2025

(30) Foreign Application Priority Data
Mar. 2, 2023 (EP) 23159803.8

(51) Int. Cl. H01F 41/02; H01F 3/02

(52) U.S. Cl. CPC H01F 41/0233; H01F 3/02

(57) ABSTRACT

A method is demonstrated for stacking sheet metal parts made from an electrical steel strip or sheet to form a laminated core. In order to achieve freedom from leakage, it is proposed for the stacking to be carried out in such a way that all of the sheet metal parts in the stack are positioned at a rotational angle that is offset in the circumferential direction of the stack relative to their respective adjacent sheet metal part or adjacent sheet metal parts.

### FIELD OF THE INVENTION

The invention relates to a method for packaging sheet metal parts made from an electrical steel strip or sheet to form a laminated core, in which the sheet metal parts—which each have a hot-melt adhesive varnish layer, more particularly a thermosetting one, more particularly a backlack, over the entire surface on both of their flat sides—are stacked on top of one another specifically in such a way that in the stack of stacked sheet metal parts, at least one sheet metal part is positioned at a rotational angle that is offset in the circumferential direction of the stack relative to an adjacent other sheet metal part and the stacked sheet metal parts are subsequently bonded together over their entire surface by means of their hot-melt adhesive varnish layers to form a laminated core.

### BACKGROUND OF THE INVENTION

A reduced size together with increased power density in laminated cores requires a cooling with cooling liquid that flows around the laminated core and/or also through it, for example with the aid of cooling channels—which requires there to be no gaps between the layers, each comprising a single sheet metal part or multiple sheet metal parts positioned next to one another. For this purpose, it is known, for example, to bond stacked sheet metal parts to one another with a layer of hot-melt adhesive varnish between the layers. However, due to parameter fluctuations in the packaging process for manufacturing the laminated core, due to undesirable impairments to the properties of the hot-melt adhesive varnish layer, or due to other negative influencing factors, the formation of gaps between the layers cannot be ruled out with certainty—especially if a high liquid pressure is exerted on the laminated core. Laminated cores of this kind therefore often cannot be used in high-performance applications with intensive cooling requirements.

In order to compensate for geometric deviations in the laminated core, it is also known for stack sections having multiple stacked sheet metal parts to be positioned at a rotational angle that is offset in the circumferential direction of the stack relative to other sheet metal parts.

### SUMMARY OF THE INVENTION

The object of the invention, therefore, is to modify the design of a laminated core of the type described at the beginning in such a way that it can be subjected to a liquid cooling even at high hydraulic pressure without becoming unstable, thereby allowing it to be used universally.

By stacking according to the invention in such a way that all of the sheet metal parts in the stack are positioned at a rotational angle that is offset in the circumferential direction of the stack relative to their respective adjacent sheet metal part or adjacent sheet metal parts, it is surprisingly possible to significantly increase the stability of the laminated core with respect to the penetration of liquid between its layers. The angular offset can interrupt a larger gap formation between the adjacent layers of hot-melt adhesive varnish—presumably because the undulations, which in most cases are parallel, of the adjacent layers of hot-melt adhesive varnish can be made to intersect by means of the angular offset. It is thus possible to avoid the presence of continuous gaps—which can ensure that laminated cores without gaps are able to withstand high hydraulic pressures, as is required, for example, for internal cooling of a laminated core of a stator and/or rotor in the high-performance range.

This method step also does not require any complex handling steps, which can thus result in a reproducible manufacture of leakage-free laminated cores.

The laminated core according to the invention can therefore not only be used robustly even at high hydraulic pressures, but can also be manufactured cost-effectively and reproducibly.

A rotation angle that is offset in the circumferential direction of the stack can be achieved in an easy-to-handle way by rotating the sheet metal part to be stacked on another sheet metal part in the circumferential direction of the stack in order to produce the rotation angle offset in the stack.

Alternatively or additionally, it is also conceivable for the stack to be rotated around its circumferential direction.

Preferably, a rotation angle φ in the range from 20 to 160 degrees is used for the rotation angle offset in order to thus be able to reliably interrupt parallel undulations.

This is more particularly the case if the rotation angle φ is 90 degrees.

A rotation angle offset can be selected independently of the method if the stacked sheet metal parts are embodied as axially symmetrical in relation to a longitudinal axis extending through the middle of the stack.

Preferably, the hot-melt adhesive varnish layers of the sheet metal parts to be stacked are in the B-state, which can further facilitate the packaging of leakage-free laminated cores.

If each sheet metal part has hot-melt adhesive varnish layers with different Martens hardnesses on its two opposing flat sides, this difference in hardness can further help to compensate for undulations at interfaces between the hot-melt adhesive varnish layers. This can thus further improve the leakage-free properties of the laminated core.

The Martens hardness HM is determined in accordance with DIN EN ISO 14577 using a force indentation depth method at a maximum force Fₘₐₓ (depth hardness). A pyramid-shaped indenter with a square base (Vickers indenter) is pressed into the surface of the test specimen with a constant increase in force. The indentation force and indentation depth are measured and the Martens hardness is calculated from this. The indentation force is increased up to a specified maximum force Fₘₐₓ within a specified period of time in seconds in the form of an increasing force ramp. The maximum force Fₘₐₓ is determined according to the Bückle rule, which states that the maximum penetration depth of the indenter must not exceed 10% of the layer thickness. An average value curve is generated based on at least five measurements at different points on the surface, from which the characteristic values and standard deviation are calculated.

Preferably, the sheet metal parts are stacked in such a way that the hot-melt adhesive varnish layers between two adjacent sheet metal parts have different Martens hardnesses. This means that a softer layer of hot-melt adhesive varnish is always in contact with a harder layer of hot-melt adhesive varnish, which can make a gap-free interface more stable.

Preferably, the hot-melt adhesive varnish layer on the first flat side of each sheet metal part has a Martens hardness HM in the range from 50 to 700 MPa. More preferably, the hot-melt adhesive varnish layer on the first flat side of each sheet metal part has a Martens hardness HM in the range from 100 to 500 MPa.

Preferably, the hot-melt adhesive varnish layer on the second flat side of each sheet metal part has a Martens hardness HM in the range from 50 to 700 MPa. More preferably, the hot-melt adhesive varnish layer on the second flat side of each sheet metal part has a Martens hardness HM in the range from 100 to 500 MPa.

Freedom from gaps at the interfaces can be guaranteed to be more stable if the Martens hardnesses HM of the hot-melt adhesive varnish layers on the first and second flat side of each sheet metal part differ by at least 20 MPa. Preferably, the Martens hardnesses of the hot-melt adhesive varnish layers on the first and second flat side of each sheet metal part differ by at least 50 MPa.

The above can be further improved if, when being subjected to pressure, at least the hot-melt adhesive varnish with the lower Martens hardness (HM) has a temperature greater than its glass transition temperature. Preferably, the hot-melt adhesive varnish with the lower Martens hardness has a temperature in the range from 80 to 220° C.

Preferably, the Martens hardnesses (HM) are determined at a test temperature in the temperature range between the lowest glass transition temperature Tg of the hot-melt adhesive varnish layers and the highest glass transition temperature Tg of the hot-melt adhesive varnish layers. For example, this temperature is above room temperature, a conceivable range being from 45 to below 80 degrees Celsius in this case. This further contributes to a balancing-out of the undulations at interfaces between the hot-melt adhesive varnish layers. This is more particularly the case if the sheet metal parts are bonded through a thermal activation of the hot-melt adhesive varnish layers.

A contribution to the absence of gaps between the individual laminations can also be made by subjecting the stacked sheet metal parts to pressure in the longitudinal direction L of the stack. This pressure can also compensate for surface undulations in the case of hot-melt adhesive varnish layers with different Martens hardnesses HM. Preferably, the stacked sheet metal parts are subjected to pressure in the range from 0.5 to 10 N/mm² in the longitudinal direction L of the stack. Preferably, this exertion of pressure takes place when the sheet metal parts are being glued together.

The cooling of the laminated core can be improved if the sheet metal parts have a channel opening and if they are stacked on top of one another in such a way that their channel openings delimit a cooling channel that extends in the laminated core and is positioned eccentrically to a longitudinal axis of the laminated core extending through the middle of the laminated core.

The productivity of the packaging method in terms of producing leakage-free laminated cores can be further increased if an electrical steel strip or sheet is provided with the hot-melt adhesive varnish layers over the entire surface of both flat sides and then the sheet parts to be stacked on top of one another are separated from the electrical steel strip or sheet.

### BRIEF DESCRIPTION OF THE DRAWINGS

The subject matter of the invention is shown in the figures by way of example based on several embodiment variants. In the drawings:

FIG. 1 shows a schematic view of an apparatus for producing laminated cores composed of first or second sheet metal parts,

FIG. 2 shows an enlarged partial view of the apparatus from FIG. 1,

FIG. 3a shows a plan view of the uppermost sheet metal part of a stack shown in FIG. 2 after a rotation by means of a counter-support of the apparatus from FIG. 1,

FIG. 3b shows a plan view of the stack with a new separated sheet metal part,

FIG. 4a shows a detail view of FIG. 3b, and

FIG. 4b shows an enlarged sectional view according to I-II of FIG. 4a.

### DETAILED DESCRIPTION OF THE INVENTION

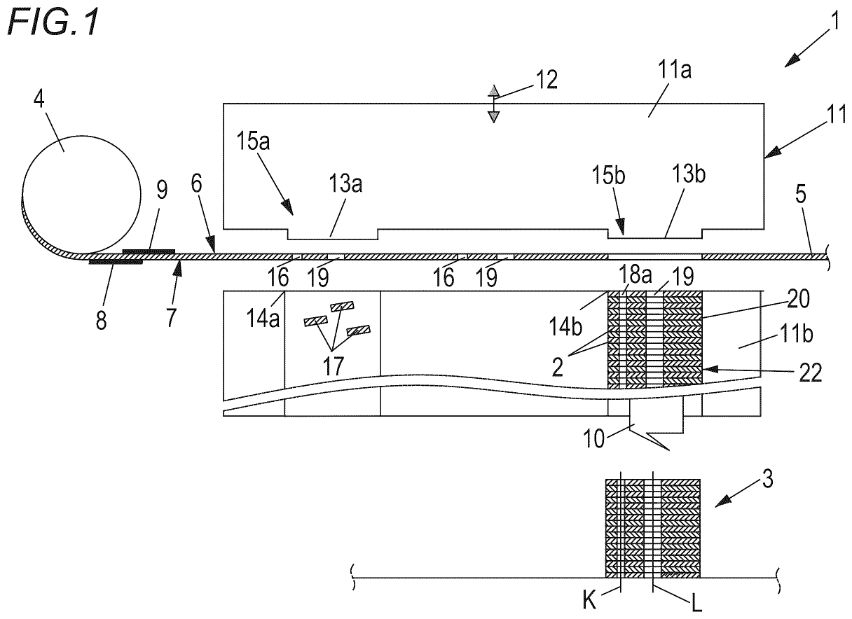

FIG. 1 schematically depicts an exemplary embodiment of an apparatus 1 for carrying out the method according to the invention. This apparatus 1 is used for packaging laminated cores 3 made of laminated sheet metal parts 2. To accomplish this, an electrical steel strip 5 is unwound from a coil 4 (or taken from a sheet in the case of a sheet of electrical steel), which has a hot-melt adhesive varnish layer 8, 9 on both flat sides 6 and 7 over their entire surface—only schematically indicated in FIG. 1—, namely a backlack, in the B-state. The layer thickness of each layer is 4 μm (micrometers). The electrical steel strip 5 has a grade of NO25-13 Y420 and a strip thickness of 0.3 mm (millimeters).

It should be mentioned, for example, that such a thermally activatable and thus heat-curing hot-melt adhesive varnish layer (often also referred to as a hot-melt glue layer) is known by the name “backlack.” For example, the hot-melt adhesive varnish can have an epoxy resin base. Preferably, the hot-melt adhesive varnish is a bisphenol-based epoxy resin system with a hardener, for example with a dicyandiamide base. More particularly, the hot-melt adhesive varnish mentioned above can be a bisphenol-A epichlorohydrin resin system with dicyanamide as hardener. This two-stage curing epoxy resin system is in the B-state on the sheet or the sheet metal strip. This means that the partially cross-linked hot-melt adhesive varnish is reactive. When heat is applied, the hot-melt adhesive varnish in the B-state reacts further and can thus be converted to the fully cross-linked C-state—also known as baking or final curing. Typically, this partially cross-linked hot-melt adhesive varnish layer has a thickness of a few micrometers.

Multiple sheet metal parts 2 are separated, namely punched out, from the adhesive-coated electrical steel strip 5 using a punching tool 11—in the exemplary embodiment, a progressive punching tool. Such a punching-out can—generally speaking—be a cutting out, cutting off, notching, trimming, cutting by pressing out, etc. A laser cutting is also conceivable, but this is not shown.

As can also be seen in FIG. 1, the punching tool 11 performs a cutting with multiple strokes 12. For this purpose, the cutting edges 13a, 13b in the upper tool 11a of the punching tool 11 interact with the respective dies 14a, 14b of the lower tool 11b of the punching tool 11 and thus form two punching stages 15a, 15b in the punching tool 11.

With the first cutting edge 13a of the upper tool 11a, multiple channel openings 16 are produced in, namely punched into, the electrical steel strip 5—which can be seen in FIG. 1 from the punched-out remnants 17. The channel openings 16 are provided in the electrical steel strip 5 for each individual sheet metal part 2 to thus enable provision of multiple cooling channels 18a, 18b extending through the entire laminated core 3. A central recess 19 is also provided to accommodate a rotor shaft, which is not shown in detail.

The cutting edge 13b is used to separate the sheet metal part 2 from the electrical steel strip 5—this is done with the aid of the punching stage 15b, which punches out the sheet metal parts 2, forces them into a stacking device 20 by pressure from the upper tool 11a, and stacks them there to form a stack 22. The stacking device 20 has a guide for this purpose in the lower tool 11b. A counter-support 10, partially shown in FIG. 1, is also provided in the guide.

The stacking device 20 is actively heated in order to thermally activate the backlack layer of the sheet metal parts 2 and produce an adhesive bond, i.e. an integral bond, between the sheet metal parts 2. In this way, the hot-melt adhesive varnish 8 is baked and thus transferred from the B-state to the C-state, which laminates the sheet metal parts 2 to form a laminated core 3.

The cooling channels 18 are each positioned eccentrically to a longitudinal axis L of the laminated core 3 extending through the middle of the laminated core 3 and therefore do not extend centrally through the laminated core 3, as can be seen in FIG. 1. In the exemplary embodiments, the longitudinal axis L is the central longitudinal axis of the laminated core 3, i.e. a longitudinal axis L extending through the middle of the laminated core 2. In the exemplary embodiment, this longitudinal axis L is also an axis of symmetry of the laminated core, for example. A receptacle 21 in the laminated core 3 extends centrally through the laminated core since the laminated core 3 is used as a rotor for an electric machine 100 and the receptacle 21 is used for a rotor shaft. However, it is also conceivable for the laminated core 3 to be used as a stator and for the receptacle 19 to be provided to receive a rotor, which is not shown.

According to the invention, all of the sheet metal parts 2 in the stack 22 are positioned at a rotational angle that is offset in the circumferential direction U of the stack 22 relative to their respective adjacent sheet metal part 2 or adjacent sheet metal parts 2. This is achieved by rotating the stack 22 by a 90 degree rotation angle φ before an additional separated sheet metal part 2 is placed onto it. It is also conceivable, however, for the new sheet metal part 2, which is to be stacked onto the other sheet metal parts 2, to be rotated in its circumferential direction U, which has not been shown in greater detail.

This rotation is also unproblematic in relation to the cooling channels 18a, 18b since the stacked sheet metal parts 2 are embodied as axially symmetrical in relation to a longitudinal axis L extending through the middle M of the stack 21. This means that the channel openings 16 are aligned with the corresponding cooling channels 18a, 18b even after the stack has been rotated.

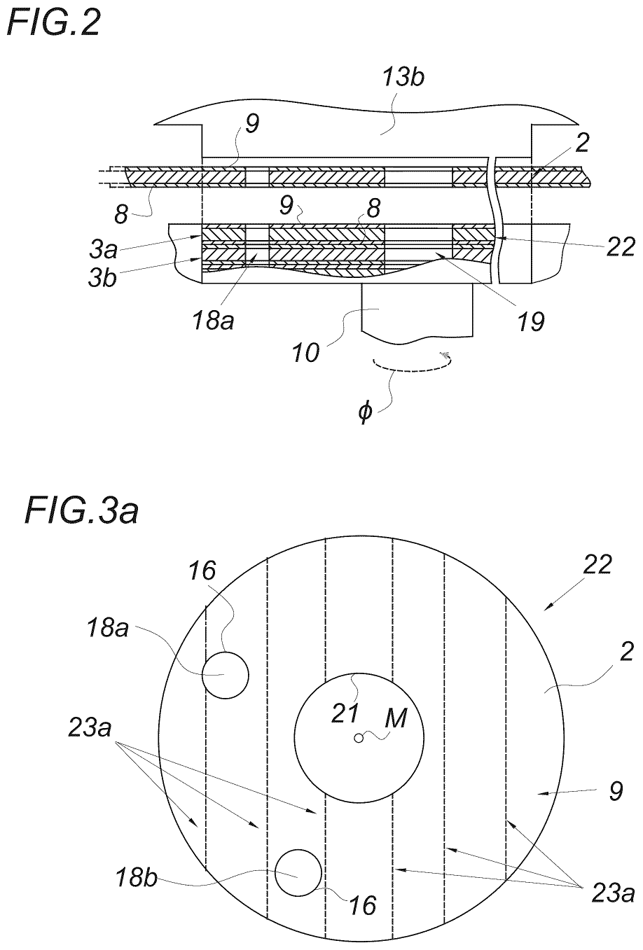

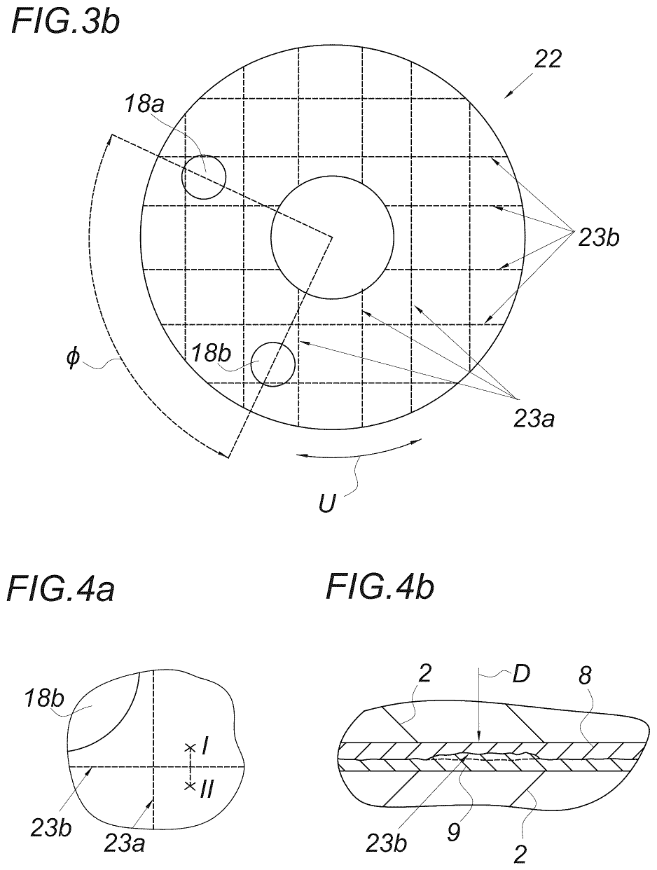

This angular offset of all of the sheet metal parts 2 of the stack 22 means that, as shown in FIG. 3b, a continuous gap formation between the layers 3a, 3b of the laminated core 3, which is shown by way of example in FIG. 2, is reliably interrupted. After the angular offset, the wave troughs 23a, 23b of the surface undulations, which are almost parallel on each sheet metal part 2, cross each other. This reliably interrupts the wave troughs 23a, 23b by superimposing their wave fronts, as shown in FIGS. 4a and 4b.

A leakage through two adjacent hot-melt adhesive varnish layers therefore cannot occur so that the laminated core according to the invention can withstand a liquid cooling even at high hydraulic pressure.

This is further improved by the fact that for each sheet metal part 2, the hot-melt adhesive varnish layers 8, 9 on the opposite flat sides 6, 7 have a different Martens hardness HM compared to each other.

For example, the hot-melt adhesive varnish layer 8 on the flat side 6 has a Martens hardness HM of 400 MPa (megapascals), whereas the hot-melt adhesive varnish layer 9 on the opposite flat side 7 has a Martens hardness HM of 300 MPa. The hot-melt adhesive varnish layers 8, 9 on the first and second flat sides 6, 7 therefore differ by 100 MPa in their Martens hardness HM.

These Martens hardnesses HM were determined according to DIN EN ISO 14577 at room temperature in the vicinity of 23° C. (degrees Celsius) and at 45% relative humidity using a force penetration depth method with a force ramp. A Fischerscope HM 2000 with a Vickers indenter was used as the measuring device. The following test parameters were used:

Maximum force Fmax: 10 mN (millinewtons). Continuous increase of the force to this maximum force Fmax, i.e. F=0 mN at time 0 and F reaches the maximum force Fmax =10 mN at time 20 s (seconds).

Measurement duration: 20 seconds

The penetration depth was selected at 10% of the layer thickness.

To ensure the liquid-tight bonding, it is particularly advantageous if the different Martens hardnesses HM are measured at a higher test temperature, namely in the range from 45 to below 80° C. (degrees Celsius), for example at 55° C., using the method described above in accordance with DIN EN ISO 14577. The test temperature is thus in the temperature range between the lowest glass transition temperature Tg, namely 50° C., of the hot-melt adhesive varnish layer 9 and the highest glass transition temperature Tg, namely 60° C., of the hot-melt adhesive varnish layer 8.

In this case, the hot-melt adhesive varnish layer 8 (Tg=60° C.) also has a measured Martens hardness HM in the vicinity of 400 MPa (megapascals). By contrast, the hot-melt adhesive varnish layer 9 (Tg=50° C.) has a Martens hardness HM of only 50 MPa. The difference (350 MPa) between the hot-melt adhesive varnish layers 8 and 9 is therefore more significant, which increases the suitability of the two hot-melt adhesive varnish layers 8 and 9 for compensating for undulations at their interfaces and thus further improves the reproducibility of the method.

The higher hardness of the hot-melt adhesive varnish layer 8 on the flat sides 6 of the sheet metal part 2 is achieved, for example, by using a reaction accelerator. This is accomplished, for example, by spraying a reaction accelerator onto this hot-melt adhesive varnish layer 8, which has the same composition as the hot-melt adhesive varnish layers 8, 9. The reaction accelerator can also be contained in the hot-melt adhesive varnish layer 8 in order to achieve the same effect. For example, 2-ethyl-4-methylimidazole can be used as a reaction accelerator in backlack that is used for the hot-melt adhesive varnish layer 8.

The sheet metal parts 2 are now stacked in such a way that the hot-melt adhesive varnish layers 8 and 9 between two adjacent sheet metal parts 2 have different Martens hardnesses HM.

This allows any remaining gaps between the layers 3a, 3b to be reliably closed by forcing the softer hot-melt adhesive varnish layer 9 into the wave valleys 23a of the harder hot-melt adhesive varnish layer 8.

This is more particularly extremely effective if the softer hot-melt adhesive varnish 9 is heated to a temperature greater than its glass transition temperature (Tg), namely 120° C. (degrees Celsius). This heating can take place, for example, during the baking of the sheet metal parts.

In addition, the exertion of pressure on the stack 22 in its longitudinal direction L has the advantage of ensuring that the wave troughs 23a, 23b are interrupted. This exerted pressure is 2 N/mm² (Newtons per square millimeter), for example for 60 seconds.

It should be noted in general that the German expression “insbesondere” can be translated as “more particularly” in English. A feature that is preceded by “more particularly” is to be considered an optional feature, which can be omitted and does not thereby constitute a limitation, for example, of the claims. The same is true for the German expression “vorzugsweise”, which is translated as “preferably” in English.

1. A method for packaging sheet metal parts made from an electrical steel strip or sheet to form a laminated core, comprising:
stacking a plurality of the sheet metal parts, each of which has a hot-melt adhesive varnish layer over an entire surface on both flat sides, on top of one another in such a way that in a stack of the stacked sheet metal parts, each of the plurality of sheet metal parts is positioned at a rotational angle that is offset in a circumferential direction of the stack relative to an adjacent sheet metal part or adjacent sheet metal parts, and
subsequently bonding the stacked sheet metal parts to one another over the entire surface of the sheet metal parts with the hot-melt adhesive varnish layers to form the laminated core.

2. The method according to claim 1, wherein in order to produce the rotational angle offset in the stack, the sheet metal part to be stacked on another sheet metal part is rotated in the circumferential direction of the stack and/or the stack is rotated about its circumferential direction.

3. The method according to claim 1, wherein a rotational angle (φ) in a range from 20 to 160 degrees is used for the rotational angle offset.

4. The method according to claim 3, wherein the rotational angle (φ) is 90 degrees.

5. The method according to claim 1, wherein the stacked sheet metal parts are embodied as axially symmetrical in relation to a longitudinal axis extending through a middle of the stack.

6. The method according to claim 1, wherein the hot-melt adhesive varnish layers on the sheet metal parts to be stacked are in a B-state.

7. The method according to claim 1, wherein on its two opposite flat sides, each of the plurality of sheet metal parts has hot-melt adhesive varnish layers with different Martens hardnesses, determined according to DIN EN ISO 14577 with a force penetration depth method at a maximum force Fmax (depth hardness).

8. The method according to claim 7, wherein each of the plurality of sheet metal parts is stacked in such a way that the hot-melt adhesive varnish layers between two adjacent sheet metal parts have different Martens hardnesses.

9. The method according to claim 7, wherein the hot-melt adhesive varnish layer on a first and/or second flat side of each sheet metal part have/has a Martens hardness in a range from 50 to 700 MPa.

10. The method according to claim 7, wherein the Martens hardnesses of the hot-melt adhesive varnish layers on the two opposite flat sides of each sheet metal part differ by at least 20 MPa.

11. The method according to claim 7, wherein the Martens hardnesses are determined at a test temperature in a temperature range between a lowest glass transition temperature of the hot-melt adhesive varnish layers and a highest glass transition temperature of the hot-melt adhesive varnish layers.

12. The method according to claim 1, wherein the stacked sheet metal parts are subjected to pressure in a longitudinal direction of the stack.

13. The method according to claim 12, wherein when being subjected to pressure, at least the hot-melt adhesive varnish with a lower Martens hardness has a temperature greater than its glass transition temperature.

14. The method according to claim 12, wherein the stacked sheet metal parts are subjected to pressure in a range from 0.5 to 10 N/mm² in the longitudinal direction of the stack during the bonding.

15. The method according to claim 1, wherein the sheet metal parts each have at least one channel opening and are stacked on top of one another in such a way that the channel openings delimit a cooling channel that extends in the laminated core and is positioned eccentrically with respect to a longitudinal axis of the laminated core extending through a middle of the laminated core.

16. The method according to claim 1, comprising providing an electrical steel strip or sheet with the hot-melt adhesive varnish layers over an entire surface on two flat sides, and separating the plurality of the sheet metal parts to be stacked on top of one another from the electrical steel strip or sheet.

17. The method according to claim 9, wherein the hot-melt adhesive varnish layer on the first and/or second flat side of each sheet metal part have/has a Martens hardness in a range from 100 to 500 MPa.

18. The method according to claim 10, wherein the Martens hardnesses of the hot-melt adhesive varnish layers on the two opposite flat sides of each sheet metal part differ by at least 50 MPa.

19. The method according to claim 11, wherein the Martens hardnesses are determined at a test temperature in a temperature range from 45 to below 80 degrees Celsius.

20. The method according to claim 12, wherein when being subjected to pressure, at least the hot-melt adhesive varnish with the lower Martens hardness has a temperature in a range from 80 to 220° C.
